(19) United States
(12) Patent Application Publication
(10) Pub. No.: US 2009/0139264 A1
(43) Pub. Date: Jun. 4, 2009

(54) ANTIQUE JEWELRY ARTICLES AND METHODS OF MAKING SAME

(76) Inventor: Rachel BROWN, New York, NY (US)

Correspondence Address: WINSTON & STRAWN LLP;PATENT DEPARTMENT, 1700 K STREET, N.W., WASHINGTON, DC, 20006, US

(21) Appl. No.: 12/268,770

(22) Filed: Nov. 11, 2008

Related U.S. Application Data
(60) Provisional application No. 60/991,585, filed on Nov. 30, 2007.

(51) Int. Cl. A44C 9/00; B05D 1/12; A44C 25/00; A44C 5/00

(52) U.S. Cl. 63/15; 427/289; 427/292; 63/34; 63/3

(57) ABSTRACT

A gold plated jewelry article that has an antique, ancient or aged appearance and methods of making the same. The method includes providing a matte finish on an engravable article having a desired shape and being made of a metal or alloy that is less precious than gold; plating all visible surfaces of the engravable article with a thin layer of gold; and engraving characters on at least one surface of the engravable article. During use, the gold plated jewelry article wears or deteriorates to exhibit the antique, ancient or aged appearance.

This application claims the benefit of application No. 60/991,585 filed Nov. 30, 2007, the content of which is expressly incorporated herein by reference thereto.

### BACKGROUND

The invention relates to a gold plated jewelry article that has an antique, ancient or aged appearance and to methods of making the same. The method includes providing a matte finish on an engravable article having a desired shape and being made of a metal or alloy that is less precious than gold; plating all visible surfaces of the engravable article with a thin layer of gold; and engraving characters on at least one surface of the engravable article. During use, the gold plated jewelry article wears or deteriorates to exhibit the antique, ancient or aged appearance, or it can be distressed prior to wearing to accelerate the aged appearance of the article.

It is generally known in the art to prepare lustrous, clean, and bright jewelry articles that can be worn to provide a rich-looking or modern appearance. It is also known to electroplate gold on older or worn jewelry articles to restore such an appearance. Typically, it is not considered to be desirable to prepare old-looking or aged jewelry articles especially due to the relatively high cost of the precious metals that are used to prepare such articles. And in those situations where jewelry articles are old and are passed down from generation to generation, the aging process occurs gradually and over a period of many years.

It has now been found, however, that there is a need for antique or aged articles in certain circumstances and thus that a method for conveniently preparing such articles in a much shorter time frame is needed. The invention now satisfies these needs.

### SUMMARY OF THE INVENTION

The invention relates to a method of making a gold plated jewelry article that has an antique, ancient or aged appearance. This method comprises providing a matte finish on an engravable article having a desired shape and being made of a metal or alloy that is less precious than gold; plating all visible surfaces of the engravable article with a thin layer of gold; and engraving characters on at least one surface of the engravable article. During use, the gold plated jewelry article wears or deteriorates to exhibit the antique, ancient or aged appearance.

Typically, the matte finish is obtained by buffing a polished metal article. Advantageously, the engravable metal article is made of silver, a silver alloy, copper, brass, bronze, steel, or stainless steel and after plating no further finishing or sealing is applied to or upon the gold plating. Preferably, the article is made or sterling silver and if it is initially polished a buffing device can be used to provide the matter finish. Also, the engravable article has a shape that corresponds to that of the gold plated jewelry article.

The engraving can be conducted in different ways. In one embodiment, the engraving is conducted after plating to obtain a contrast between the engraved characters and the gold plating. The contrast is particularly noticeable between the engraving and gold plating when the article is made of silver or other light metal. Alternatively, the engraving is conducted before plating to provide gold plating on the engraved characters. Preferably, the engraving is diamond engraving.

While any alphanumeric characters or symbols can be used, the most desirable characters are Kabbalistic characters or hebrew letters. The article can have the shape of a disk or ring and, alone or in combination with other jewelry articles, can form a ring, bracelet, or necklace. The gold plating may be 24 carat gold, 18 carat gold, 14 carat gold, green gold or pink gold. To more quickly develop the antique, ancient or aged appearance, the article can be distressed.

The invention also relates to a gold plated jewelry article that has an antique, ancient or aged appearance. The article comprises a matte finish engravable article having a desired shape and being made of a metal or alloy that is less precious than gold; a thin layer of gold plating on all visible surfaces of the engravable article; and engraved characters on at least one surface of the engravable article. The gold plated jewelry article exhibits the antique, ancient or aged appearance, and this can be attained by distressing the article before wearing or upon usual wear and use.

### DETAILED DESCRIPTION OF THE PREFERRED EMBODIMENTS

The following describes the process through which an antique finish is provided to the jewelry articles of the invention.

The first step is to obtain a piece of jewelry which has the desired shape and size and that also is made of a relatively soft, machinable or engravable metal. A wide variety of metals can be used, including silver, silver alloys, copper, copper alloy such as brass or bronze, steel or its alloys, or stainless steels. Preferably, sterling silver or 70:30 brass is used depending upon the final appearance of the jewelry article as described herein. Sterling silver is readily available in a variety of shapes and sizes and with a standard polished finish. The size and shape can be selected to conform to that of the final jewelry article, e.g., a ring, or it can be used as a component of the final jewelry article.

When this silver alloy or other polished articles are used as a starting material, the polish is first removed by a conventional buffing machine to provide a matte finish to the article. An instrument called a “yellow rouge” is typically used to buff the piece to change the finish. Of course, it is not necessary to start with a polished article and it is entirely appropriate to simply begin with a metal or alloy that has a matte finish. Scratches or other surface imperfections can be removed with a conventional “trepule” instrument if desired or they can be left in the article to contribute to the antique, ancient or aged appearance of the final gold plated article.

Next the matte finish article is cleaned to remove surface contamination that might interfere with the gold plating operation. A steam machine can be used to clean off dirt, while a conventional degreaser can be used to remove oils or organic residues. Sufficient care is necessary in the cleaning process to insure that all polishing rouge, oil, grease, finger prints, etc. are removed. For best results, the articles to be plated should be cleaned at 5-6 volts in a KROHN TIVACLEAN solution (8 oz. per gallon of water heated to 160-180 F) followed by a cold water rinse.

The article is then gold plated in a conventional manner. A relatively thin gold layer is provided. The thickness of the layer is typically about 50 to 100 microns although thinner or thicker layers can be applied if desired. Any of the conventional types of gold plating can be used. The type of gold to be plated may be 24 carat gold, 18 carat gold, 14 carat gold, green gold or pink gold, as desired based on the type of color to be provided in the final article. For 24 carat gold, for example, a solution called KROHN READY-TO-USE GOLD ELECTROPLATING SOLUTION, from KROHN TECHNICAL PRODUCTS, Carlstadt, N.J. 07072 can be used. The recommended plating bath temperature is 130-140 F. Gold plating is accomplished using 4 to 6 volts and an insoluble stainless steel or a soluble gold anode. If water is lost in the bath due to evaporation, distilled water can be added to maintain level of bath. The plating time should be 15 to 30 seconds or until the desired coverage, thickness and color are obtained. Overplating can be used to darken the final color if desired. Other gold plating solutions are generally known in the art and any of these can be used to achieve the desired color of the gold plating.

The gold plated articles are then thoroughly rinsed in distilled water and dried. Next, the plated articles are then engraved with the desired characters. One particularly preferred type of characters are those embodied in Kabbalistic meditations and are typically composed of Hebrew letters. Standard engraving procedures are used to engrave these characters. When the starting article is of a color that contrasts with the gold plating, engraving the characters after plating exposes the color of the article and provides a pleasing contrast: e.g., a silver article and green gold plating results in the appearance of bright silver characters surrounded by the green gold plating.

Kabbalistic meditations are preferred characters due to their longstanding use and acceptance. Kabbalah is considered to be the world's oldest body of spiritual wisdom and contains the long-hidden keys to the secrets of the universe as well as the keys to the mysteries of the human heart and soul. Kabbalistic teachings explain the complexities of the material and the nonmaterial universe, as well as the physical and metaphysical nature of all humanity. These meditations and sayings have been used for thousands of years to bring clarity, understanding, and freedom. As these meditations are very old, it has now been found that an antique, ancient or aged appearance for the gold plated jewelry article is highly desirable, since it makes the articles look like they have been around for centuries.

By following the methods of the invention, it has been found that the gold plating begins to wear off little by little fairly quickly during the time of use or wearing of the article and an antique look is quickly achieved in about a few months. The period of time in which this effect is achieved varies depending on the wearer's body temperature, body products, sweat, and energy of the person wearing the piece. Other variables that contribute to the aging of the plating and the antique look of the jewelry of the invention include heat, sun, and exposure to varying temperatures, the care of and general handling of the piece by the wearer, and its exposure to fluids or abrasion. The time period necessary to obtain the antique look can be reduced by distressing the jewelry article prior to wearing. This can be done by intentionally handling, abrading, corroding, washing, rubbing, or conducting any other operations of this type to accelerate the aging of the article.

In addition to engraving with Kabbalistic meditations, the present invention can be used to create jewelry articles that include other engraved alphanumeric characters or symbols, including names, numbers or other sayings or information. Skilled artisans can envision other uses and implementations of the jewelry articles and methods of making the same based on the disclosure presented herein, and it is intended that the claims cover all such embodiments that fall within the true spirit and scope of the invention.

What is claimed is:

1. A method of making a gold plated jewelry article that has an antique, ancient or aged appearance, which comprises:
providing a matte finish on an engravable article having a desired shape and being made of a metal or alloy that is less precious than gold;
plating all visible surfaces of the engravable article with a thin layer of gold; and
engraving characters on at least one surface of the engravable article;
wherein the gold plated jewelry article wears during use to exhibit the antique, ancient or aged appearance.

2. The method of claim 1, wherein the matte finish is obtained by buffing a polished metal article.

3. The method of claim 1, wherein the engravable metal article is made of silver, a silver alloy, copper, brass, bronze, steel, or stainless steel and after plating no further finishing or sealing is applied to or upon the gold plating.

4. The method of claim 1, wherein the engravable article has a shape that corresponds to that of the gold plated jewelry article.

5. The method of claim 1, wherein the engraving is conducted after plating to obtain a contrast between the engraved characters and the gold plating.

6. The method of claim 1, wherein the engraving is conducted before plating to provide gold plating on the engraved characters.

7. The method of claim 1, wherein the characters are Kabbalistic characters.

8. The method of claim 1, wherein the engraving is diamond engraving.

9. The method of claim 1, wherein the article has the shape of a disk or ring.

10. The method of claim 1, wherein the jewelry article, alone or in combination with other jewelry articles, forms a ring, bracelet, or necklace.

11. The method of claim 1, wherein the gold plating is 24 carat gold, 18 carat gold, 14 carat gold, green gold or pink gold.

12. The method of claim 1, which further comprises distressing the article to more quickly develop the antique, ancient or aged appearance.

13. A gold plated jewelry article that has an antique, ancient or aged appearance, comprising:
a matte finish engravable article having a desired shape and being made of a metal or alloy that is less precious than gold;
a thin layer of gold plating on all visible surfaces of the engravable article; and
engraved characters on at least one surface of the engravable article;
wherein the gold plated jewelry article exhibits the antique, ancient or aged appearance.

14. The product of claim 13, wherein the engravable metal article is made of silver, a silver alloy, copper, brass, bronze, steel, or stainless steel and has no further finishing or sealing applied to or upon the gold plating.

15. The product of claim 13, wherein the engravable article has a shape that corresponds to that of the gold plated jewelry article.

16. The product of claim 13, wherein the engraving exhibits a contrast between the engraved character and the gold plating.

17. The product of claim 13, wherein the gold plating is present upon the engraved characters.

18. The product of claim 13, wherein the characters are Kabbalistic characters or Hebrew letters.

19. The product of claim 13, wherein the jewelry article and, alone or in combination with other jewelry articles, forms a ring, bracelet, or necklace.

20. The product of claim 13, wherein the gold plating is 24 carat gold, 18 carat gold, 14 carat gold, green gold or pink gold.
